(19) United States
(12) Patent Application Publication
(10) Pub. No.: US 2007/0168742 A1
(43) Pub. Date: Jul. 19, 2007

(54) Isolating code modules

(75) Inventors: Brandon Scott Wadsworth, Redmond, WA (US); David Notario, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/282,267

(22) Filed: Nov. 18, 2005

(51) Int. Cl. G06F 11/00

(52) U.S. Cl. 714/38

(57) ABSTRACT

Execution of at least portions of applications, programs, functions, and other assemblages of programmable and executable code may be monitored to build effective test cases therefore. That is, by extracting, e.g., individual methods that occur, including input and output data, functional tests may be built and performance tests may be performed in isolation.

### BACKGROUND

Applications, programs, functions, and other assemblages of programmable and executable code are typically written for third party (i.e., “customer”) usage. Therefore, effective code is written in such a manner that third party usage scenarios are enabled and meet third party expectations.

### SUMMARY

As applications, programs, functions, and other assemblages of programmable and executable code are modularized, data associated with at least one such module of code may be monitored. One or more of the modules of code, along with the corresponding monitored data, may then be extracted for re-execution in an isolated environment.

### DESCRIPTION OF THE DRAWINGS

The present description references the following figures.

FIG. 1 shows devices communicating over a network, with the devices implementing example technologies for isolating one or more modules of code.

FIG. 2 shows an example of an execution environment for implementing example technologies for isolating one or more modules of code.

FIG. 3 shows an example tool for implementing example technologies to functionally isolate one or more modules of code.

FIG. 4 shows a sample data flow among modules of code that may be functionally isolated in accordance with example technologies described herein.

FIG. 5 shows an example processing flow in accordance with at least one example of code module isolation.

### DETAILED DESCRIPTION

Tools, systems, and methodologies for building test cases by isolating at least portions of applications, programs, functions, and other assemblages of programmable and executable code are described herein.

The description pertaining to isolating at least portions (e.g., modules) of code may relate to tools, systems, processes, instructions, techniques, and routines that may be utilized to build highly reliable test cases. However, such implementations are in no way limited to building test cases. Regardless, by monitoring or profiling a running application, program, function, or other assemblage of programmable and executable code, and capturing data that is input to- and output from portions thereof, functional tests may be built and performance tests on desired portions of code may be performed in isolation. Further, such tools, systems, and processes may be implemented in one or more devices, or nodes, in a network environment.

“Module,” as described herein, may refer to separate entities such as methods, classes, DLLs (dynamic link libraries), frameworks, etc., that may utilize common physical and/or logical resources.

“Assemblage,” as described herein, may refer to a unit of deployment for code.

“Tool,” as described herein, may refer to a multi-functional tool that may be capable of executing modules of code corresponding to an application, program, function, or other assemblage of code; monitoring, recording and/or profiling activity of the modules to thereby monitor data input to- and output from- one or more modules of code as the respective modules execute; and extracting one or more of the modules, along with recorded data corresponding thereto, into an isolated execution environment.

“Resource,” as described herein, may include both physical and logical resources associated with a respective execution environment. As non-limiting examples, such resources may range from files to ports to shared state; that is, any non-executable entity that may be shared by more than one executable entity.

“Threads,” as described herein, may refer to execution paths within an application, program, function, or other assemblage of programmable and executable code. Threads enable multiple paths or streams of execution of modules of code to occur concurrently within the same application, program, function, or other assemblage of programmable and executable code; whereby, within each stream, a different transaction or message may be processed. A multitasking or multiprocessing environment, in which multi-threading processes may be executed, may be found in either a managed execution environment or an unmanaged execution environment.

“Isolation boundary,” as described herein, may refer to a logical or physical construct that may serve as a unit of isolation. Processes are an example of an isolation boundary. Within a managed execution environment, such an isolation boundary may be referred to as an application domain, in which multiple threads of execution may be contained. Such terminology is provided as an example only. That is, the example implementations described herein are not limited to application domains or even to managed execution environments as stated above, but rather may be applied within various other isolation boundaries implementations in various execution environments. More particularly, isolation boundaries, as related to the scope of code module isolation described herein, may further pertain to machine boundaries, process boundaries, threads, and class or assembly boundaries. Even more particularly, the scope of code module isolation may pertain to public/private exposure, assemblies, or classes. Further, code module isolation may have multiple axis or annotations including, e.g., a type of resource as well as visibility of the resource.

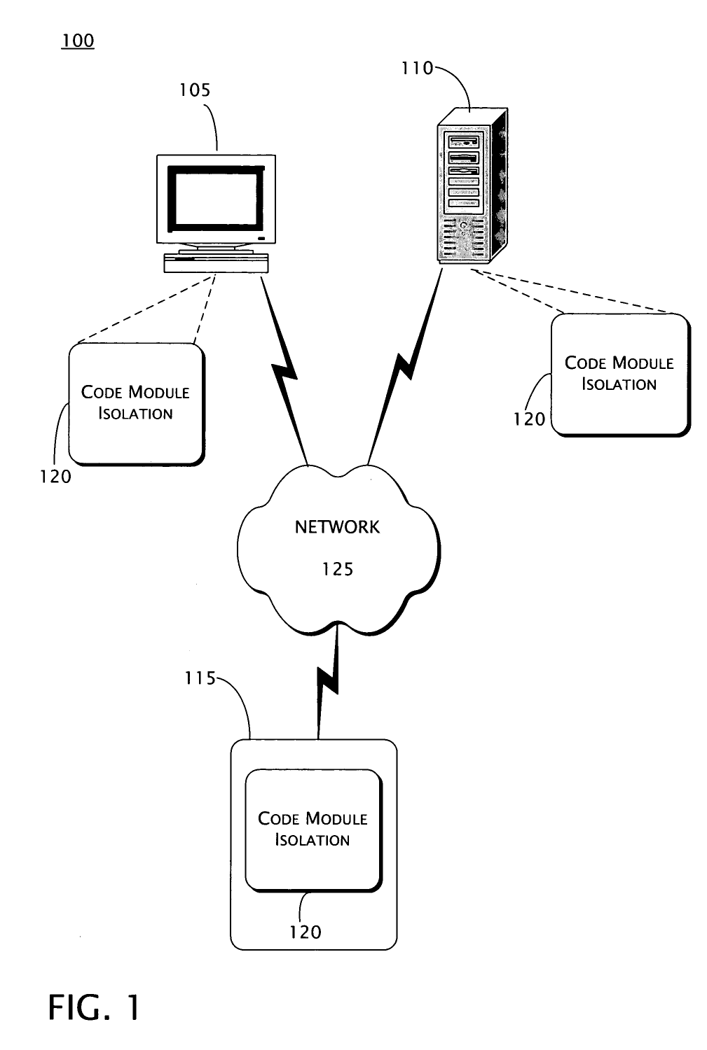

FIG. 1 shows example network environment 100 in which example technologies for isolating one or more modules of code may be implemented, although such example technologies are in no way limited to network environments. Such technologies may include, but are not limited to, tools, methodologies (e.g., techniques), and systems, associated with code module isolation 120, as described herein. In FIG. 1, client device 105, server device 110, and “other” device 115 may be communicatively coupled to one another via network 125; and, further, at least one of client device 105, server device 110, and “other” device 115 may be capable of implementing the aforementioned technologies.

Client device 105 may represent at least one of a variety of known computing devices, including a desktop personal computer (PC), workstation, mainframe computer, Internet appliance, set-top box, or gaming console, that is able to implement example technologies associated with code module isolation 120. Client device 105 may further represent at least one device that is capable of being associated with network 125 by a wired and/or wireless link, including a mobile (i.e., cellular) telephone, personal digital assistant (PDA), laptop computer, etc. Further still, client device 105 may represent the client devices described above in various quantities and/or combinations thereof. “Other” device 115 may also be embodied by any of the above examples of client device 105.

Server device 110 may represent any device that is capable of providing any of a variety of data and/or functionality to client device 105 or “other” device 115 in accordance with at least one implementation of code module isolation 120. The data may be publicly available or alternatively restricted, e.g., restricted to only certain users or only if an appropriate subscription or licensing fee is paid. Server device 110 may be at least one of a network server, an application server, a blade server, or any combination thereof. Typically, server device 110 may represent any device that may be a content source, and client device 105 may represent any device that may receive such content either via network 125 or in an off-line manner. However, according to the example implementations described herein, client device 105 and server device 110 may interchangeably be a sending node or a receiving node in network environment 100. “Other” device 115 may also be embodied by any of the above examples of server device 110.

“Other” device 115 may represent any further device that is capable of implementing code module isolation 120 according to one or more of the example technologies described herein. That is, “other” device 115 may represent any software-enabled computing or processing device that is capable of at least extracting at least one desired module of code, and corresponding input and output data, in increments of one or more isolation boundaries of an application, program, function, or other assemblage of programmable and executable code. Thus, “other” device 115 may be a computing or processing device having at least one of an operating system, an interpreter, converter, compiler, or runtime execution environment implemented thereon. These examples are not intended to be limiting in anyway, and therefore should not be construed in that manner.

Network 125 may represent any of a variety of conventional network topologies and types, which may include wired and/or wireless networks. Network 125 may further utilize any of a variety of conventional network protocols, including public and/or proprietary protocols. Network 125 may include, for example, the Internet as well at least portions of one or more local area networks (also referred to, individually, as a “LAN”), such as an 802.11 system or, on a larger scale, a wide area network (i.e., WAN”); or a personal area network (i.e., PAN), such as Bluetooth.

Computer architecture in at least one of devices 105, 110, and 115 has typically defined computing platforms in terms of hardware and software. Software for computing devices has been categorized into groups, based on function, which may include: a hardware abstraction layer (alternatively referred to as a “HAL”), an operating system (alternatively referred to as “OS”), and applications.

A runtime execution environment may reside between an OS and an application, program, function, or other assemblage of code. The runtime execution environment may serve as a space in which the application, program, function, or other assemblage of code may execute specific tasks on any one or more of processing devices 105, 110, and 115. More particularly, a runtime execution environment may enhance the reliability of the execution of an application, program, function, or other assemblage of code on a growing range of processing devices 105, 110, and 105, including servers, desktop computers, laptop computers, and mobile processing/communication devices by providing a layer of abstraction and services for an application running on such devices, and further providing the application with capabilities including memory management and configuration thereof.

A runtime execution environment may serve as at least one of a programming and an execution platform. As a programming platform, a runtime execution environment may compile one or more targeted applications, programs, functions, or other assemblages of code, which may be written in one of multiple computing languages, into an intermediate language (hereafter “IL”) or bytecode. IL is typically independent of the platform, and the central processing unit (hereafter “CPU”) executes IL. In fact, IL is a higher level language than many CPU machine languages. As an execution platform, a runtime execution environment may interpret compiled IL into native machine instructions. A runtime execution environment may utilize either an interpreter or a compiler (e.g., “just-in-time,” alternatively “JIT,” compiler) to execute such instructions. Regardless, the native machine instructions may then be directly executed by the CPU. Since IL is CPU-independent, IL may execute on any CPU platform as long as the OS running on that CPU platform hosts an appropriate runtime execution environment.

Examples of runtime environments, in which technologies associated with code module isolation 120 may be implemented, include: Visual Basic runtime environment; Java® Virtual Machine runtime environment that is used to run, e.g., Java® routines; or Common Language Runtime (CLR) to compile, e.g., Microsoft .NET™ applications into machine language before executing a calling routine. However, this listing of runtime environments provides examples only. The example technologies described herein are not limited to just these managed execution environments. More particularly, the example implementations are not just limited to managed execution environments, for one or more examples may be implemented within testing environments and/or unmanaged execution environments.

An application, program, function, or other assemblage of code compiled into IL may be referred to as “managed code,” and that is why a runtime execution environment may be alternatively referred to as a “managed execution environment.” It is noted that code that does not utilize a runtime execution environment to execute may be referred to as a native code application.

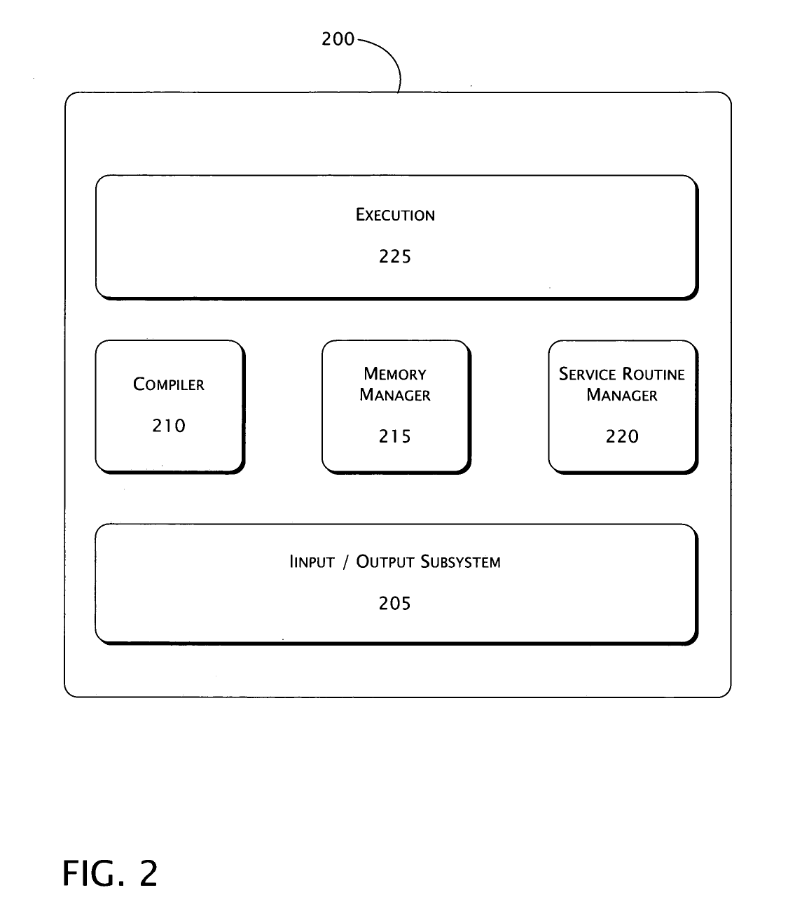

FIG. 2 shows example of runtime execution environment 200 in which technologies associated with code module isolation 120 (see FIG. 1) may be implemented.

According to at least one example implementation, runtime execution environment 200 may facilitate execution of managed code for a computing device platform. Managed code may be considered to be part of a core set of application-development technologies, and may further be regarded as an application, program, function, or other assemblage of programmable and executable code that is compiled for execution in runtime execution environment 200 to provide a corresponding service to the computing device platform. In addition, runtime execution environment 200 may translate managed code at an interpretive level into instructions that may be proxied and then executed by a processor. Alternatively, managed code may be executed via an interpreter or a compiler, or a form of a compiler designed to run at install time as a native image. A framework for runtime execution environment 200 also provides class libraries, which may be regarded as software building blocks for managed applications.

Runtime execution environment 200 may provide at least partial functionality that may otherwise be expected from a kernel, which may or may not be lacking from a computing device platform depending upon resource constraints for a particular one of devices 105, 110, and 115 (see FIG. 1). Thus, at least one example of runtime execution environment 200 may implement the following: input/output (hereafter “I/O”) routine management, compiling, memory management, and service routine management. Thus, runtime execution environment 200 may include I/O component 205, compiler 210, at least one memory management component 215, service routine management component 220, and execution component 225. These components, which are to be described in further detail below, are provided as examples, which are not intended to be limiting to any particular implementation of runtime execution environment 200, and no such inference should be made. Thus, the components may be implemented in examples of runtime execution environment 200 in various combinations and configurations thereof.

I/o component 205 of runtime execution environment 200 may provide at least one of synchronous or asynchronous access to physical resources (e.g., processor and peripherals) and logical resources (e.g., drivers, or physical resources partitioned in a particular manner) associated with the computing device platform. More particularly, I/O component 205 may provide runtime execution environment 200 with robust system throughput and further streamline performance of an application, program, function, or other assemblage of programmable and executable code from which an I/O request originates.

Compiler 210 may refer to a component within runtime execution environment 200 that may interpret compiled IL into native machine instructions for execution in runtime execution environment 200. Further, in accordance with at least one alternative implementation of technologies associated with code module isolation 120, compiler 210 may dynamically instrument for profiling/recording purposes, for various purposes, the behavior of modules of code associated with an application, program, function, or other assemblage of programmable and executable code. The modules of code may or may not be loaded into runtime execution environment 200. If the modules of code are loaded into runtime execution environment 200, the profiling may include recording or otherwise tracking interaction between the respective modules of code and one or more components of runtime execution environment 200. Such interaction between a respective module of code and a particular component of runtime execution environment 200 includes the receiving and transmitting of data, parameters, and state. The profiling may be performed without touching or affecting an executable portion of the code modules, and may be performed at compile time, initial runtime, or at any time thereafter relative to execution of an executable portion of the execution paths.

Memory management component 215 may be referred to as a “garbage collector,” which implements garbage collection. Garbage collection may be regarded as a robust feature of managed code execution environments by which an object is automatically freed (ie., de-allocated) if, upon a sweep or scan of a memory heap, an object is determined to no longer be used by an application, program, function, or other assemblage of code. Further functions implemented by memory management component 215 may include: managing one or more contiguous blocks of finite volatile RAM (i.e., memory heap) storage or a set of contiguous blocks of memory amongst the tasks running on the computing device platform; allocating memory to at least one application, program, function, or other assemblage of programmable and executable code running on the computing device platform; freeing at least portions of memory on request by at least one of the applications, programs, functions, or other assemblages of code; and preventing any of the applications, programs, functions, or other assemblages of code from intrusively accessing memory space that has been allocated to any of the other applications, programs, functions, or other assemblages of code.

Service routine manager 220 may be included as at least a portion of an application support layer to provide services functionality for physical and logical resources associated with the computing device platform. Example technologies (e.g., tools, methodologies, and systems) associated with code module isolation 120 may be managed by service routine manager 220. That is, such technologies may be implemented either singularly or in combination together by compiler 210 (as referenced above), service routine manager 220, or some other component of runtime execution environment 200, in accordance with various alternative implementations of such technologies. For example, in at least one example implementation, service routine manager 220 may at least contribute to profiling execution paths and recording interaction respective modules of code within the respective execution paths. Such contribution by service routine manager 220 may be made without touching or affecting an executable portion of the modules of code, at compile time, initial runtime, or at any time thereafter relative to execution of an executable portion of the code modules.

Execution component 225 may enable execution of managed code for the computing device platform. More particularly, with regard to implementation of technologies associated with code module isolation 120, execution component 225 may serve as an exemplary component within runtime execution environment 200 that may implement one or more of the tools, systems, and processes for isolating one or more code modules at compile time, initial runtime, or at any time thereafter during execution of an executable portion of the code modules.

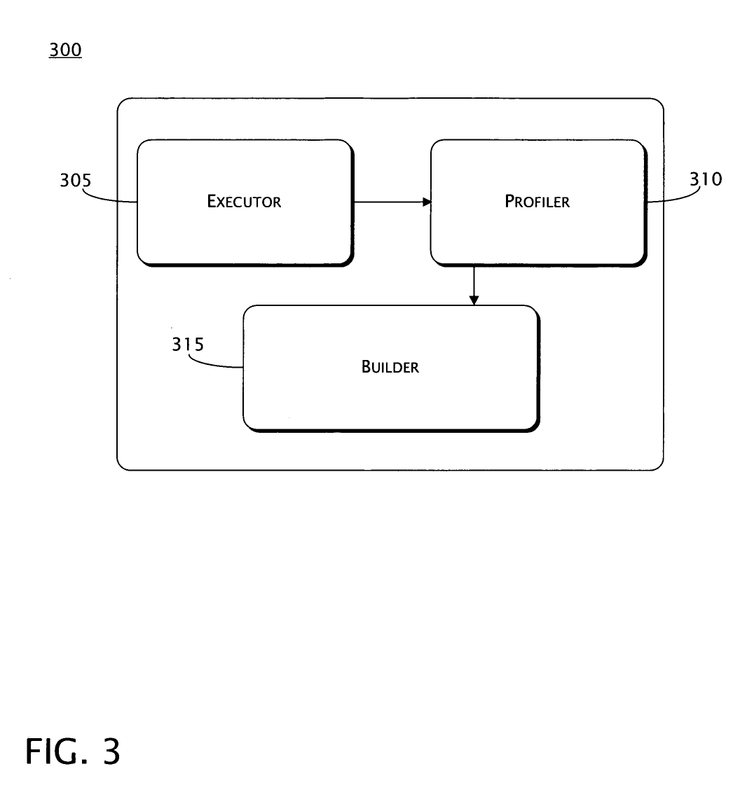

FIG. 3 shows example code isolating tool 300 that is capable of implementing one or more example technologies associated with code module isolation 120 (see FIG. 1).

In the following description, various operations will be described as being performed by components associated with code isolating tool 300. The operations that are described with respect to any particular one of these components may be carried out by the component itself, in combination with another one of the components, or by the particular component in cooperation with one or more components of runtime execution environment 200 (see FIG. 2). In addition, the operations of each of the component of code isolating tool 300 may be executed by a processor or processors and implemented as hardware, firmware, or software, either singularly or in various combinations together.

Example implementations of code isolating tool 300 may be implemented in an off-line manner, separate from any of the components of runtime execution environment 200. However, at least one implementation of code isolating tool 300 may be incorporated with any of a portion of compiler 210, service routine manager 220, or some other component of runtime execution environment 200, either singularly or in combination together. In such an implementation, code isolating tool 300 may be executed or processed by execution component 225.

Regardless, code isolating tool 300 may be utilized, at least: to execute one or more application, program, function, or other assemblage of code, which may or may not exist within a same isolation boundary; to profile the execution by collecting and/or storing data and state that are input to respective modules of code corresponding to the executable application, program, function, or other assemblage of code, and by collecting and/or storing data that is output by the respective modules of code; and to extract (i.e., isolate) one or more of the respective modules of code, as well as data and state input to the extracted code modules and data output by the extracted code modules.

Executor 305 may represent a component within code isolating tool 300 to execute, or otherwise be associated with the execution of, one or more instructions included in the modules of code associated with an executable application, program, function, or other assemblage of code that is submitted to code isolating tool 300.

Profiler 310 may represent a component within code isolating tool 300 to create a data file by collecting and/or storing data from an application, program, function, or other assemblage of code that is executing, or has been executed, by executor 305. Thus, the application, program, function, or other assemblage of code, may alternatively be referred to as being executable. Regardless, as indicated previously, code isolating tool 300 may be implemented separate from any of the components of runtime execution environment 200 or implementation of code isolating tool 300 may be incorporated with one or more components of runtime execution environment 200. Therefore, profiler 310 may profile execution of unmanaged code or managed code.

The data collected and/or stored by profiler 310 may include, at least: a time, sequence, and/or order by which data and state are input to respective modules of the executable application, program, function, or other assemblage of code; and a time, sequence, and/or order by which data is output from the respective modules.

Further still, profiler 310 may collect and/or store the data, according to the implementations described herein, in accordance with either absolute time or relative time. Absolute time may be regarded as common chronological time common to all modules of code corresponding to an executing application, program, function, or other assemblage of programmable and executable code; and relative time may be regarded as the relative time at which a module of code is executed in relation to execution of one or more other modules.

Builder 315 may represent a component within code isolating tool 300 to extract or otherwise isolate one or more of the respective modules of code corresponding to an application, program, function, or other assemblage of code executable at executor 305. In addition, builder 315 may also receive, from profiler 310, the data and/or state input to and extracted from the respective one or more modules of code extracted or otherwise isolated by builder 315.

If profiler 310 has not paired the data and/or state input to the respective modules of code with the data output as a result of such input, builder 315 may then pair the respective input and output data and/or state for the respective modules of code. Such pairing, by either profiler 310 or builder 315, may be implemented chronologically, sequentially, or by some other form of order-based pairing.

Builder 315, by extracting one or more of the respective modules of code that are executable at executor 305, may build functional tests and execute isolate performance tests for the extracted modules of code by reproducing real-world customer scenarios. That is, testing may be implemented using data and/or state that is input to a respective module in a real-world customer scenario with the benefit of knowing what output data to expect in return.

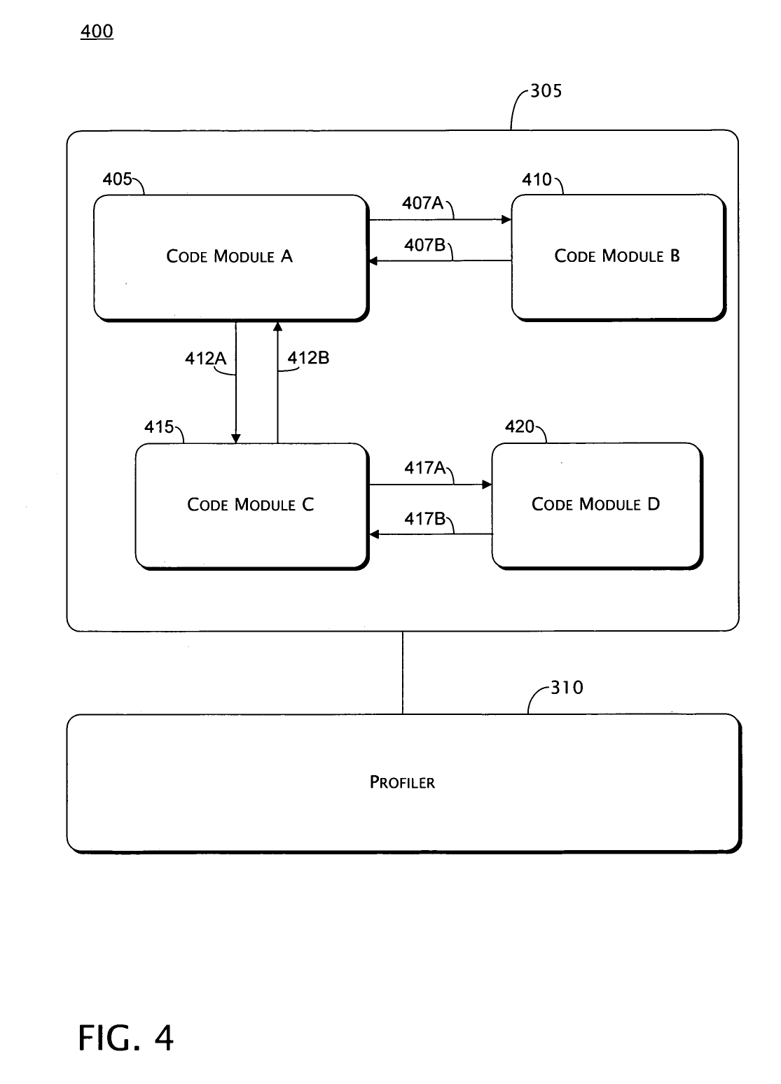

FIG. 4 shows example data flow 400, which includes sample interaction among modules of code being executed by executor 305 (see FIG. 3) that may be profiled by profiler 310 in accordance with example technologies for code module isolation 120 (see FIG. 1).

Operations that monitor, track, collect, store, or otherwise profile at least portions of example data flow 400 may be described as being performed by various components associated with code isolating tool 300 (see FIG. 3). The various operations that are described with respect to any particular one of these components may be carried out by the component itself, in combination with another one of the components, or by the particular component in cooperation with one or more components of runtime execution environment 200.

Modules 405, 410, 415, and 420 may refer to modules of executable instructions corresponding to an application, program, function, or other assemblage of code being executable in accordance with executor 305. More particularly, modules 405, 410, 415, and 420 may refer to separate entities such as methods, classes, DLLs (dynamic link libraries), frameworks, etc.

In the example of data flow 400, code module A 405 may be regarded as an entry point method at which a corresponding application, function, process, or assemblage of code may be created and begin execution. Code module B 410 may represent a child method that receives 407A data and state from code module A 405 for execution and transmits 407B data back to code module A 405 after execution. Code module C 415 may represent another child method that receives 412A data and state from code module A 405 for execution and transmits 412B data back to code module A 405 after execution. Code module D 420 may represent a sub-child method that receives 417A data and state from code module C 415 and transmits 417B data back to code module C 415 after execution. According to at least one alternative implementation of code module isolation 120, at least one of modules 405, 410, 415, and 420 may interact with runtime execution environment 200 or an operating system (i.e., OS) in an unmanaged execution environment.

Profiler 310 may monitor, track, collect, store, or otherwise profile one or more of the interaction 407A, 407B, 412A, 412B, 417A, and 417B among modules 405, 410, 415, and 420. That is, any data and state that is exchanged among modules 405, 410, 415, and 420 may be recorded, either chronologically or sequentially, by profiler 310. Further, data and state that is input to a respective one of modules 410, 415, and 420, may be profiled in association with the data and/or state that is output from the respective module. The pairing of input data and state with output data for any of modules 405, 410, 415, and 420, may be time-stamped or the sequence thereof may be otherwise noted by profiler 310. Further still, according to at least one alternative implementation of code module isolation 120, interaction between any of modules 405, 410, 415, and 420 with runtime execution environment 200 or an OS may also be profiled (i.e., recorded).

To monitor, track, collect, store, or otherwise profile one or more of the interaction 407A, 407B, 412A, 412B, 417A, and 417B among modules 405, 410, 415, and 420, profiler 310 may implement methodologies or execute techniques to perform stackwalks, which may include reporting or disclosing a sequence of frames on a call stack. A call stack in either of an unmanaged or a managed execution environment may refer to a reserved amount of memory that tracks a sequence of methods called in an application, program, function, or other assemblage of programmable and executable code. Each disclosed frame may refer to at least one of a method, routine, instruction pointer, register value, and a function name that have been pushed on the call stack. Stackwalking functionality may alternatively be referred to as stack tracing or derivatives thereof; although no limitations should be inferred by or implied by the nomenclature utilized to describe the functionality. Further, stackwalking is described herein only as an example methodology or technique that may be implemented by profiler 310, and no inferences should be made to the effect that such example limits the scope of code module isolation 120.

Further still, functionality of profiler 310 may alternatively be implemented by an instrumentation methodology or technique that is able to extract the data and/or state that are input and output from a respective one of modules 405, 410, 415, and 420.

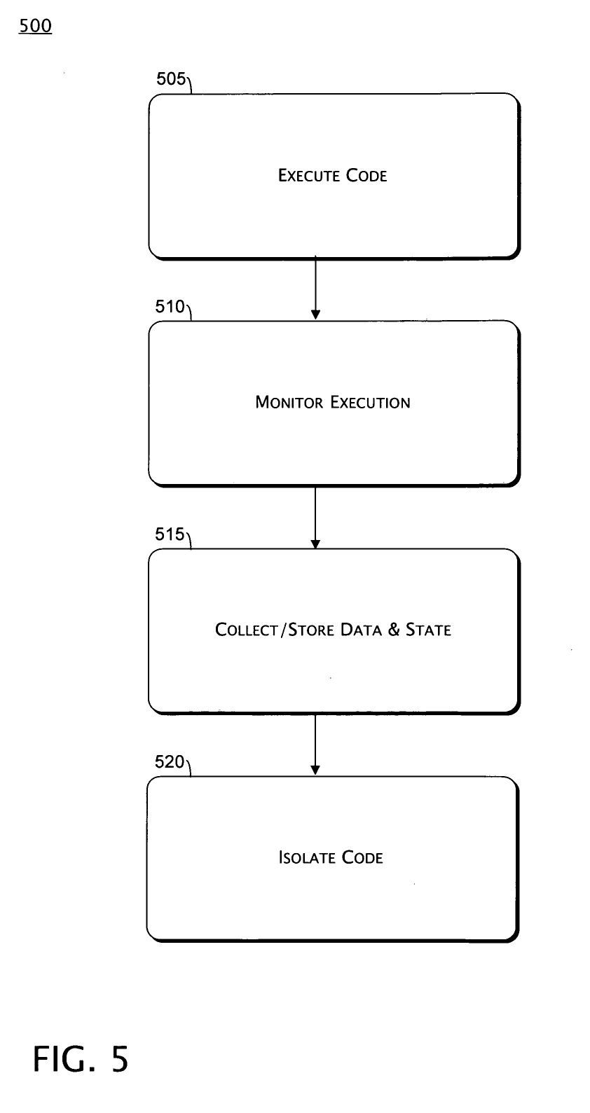

FIG. 5 shows example processing flow 500 implemented in accordance with an example technology associated with code module isolation 120 (see FIG. 1). Operations associated with processing flow 500 may be described as being performed on at least one of modules 405, 410, 415, and 420 (see FIG. 4) by various components associated with code isolating tool 300 (see FIG. 3). The operations that are described with respect to any particular one of the components of FIG. 3 may be carried out by the component itself, in combination with another one of the components, or by the particular component in cooperation with one or more components of runtime execution environment 200 (see FIG. 2).

Block 505 may refer to executor 305 executing, or otherwise being associated with the execution of, one or more of modules 405, 410, 415, and 420, which may represent separate entities such as methods, classes, DLLs (dynamic link libraries), frameworks, etc.

Block 510 may refer to profiler 310 monitoring the interaction among modules of code corresponding to an executing application, program, function, or other assemblage of code. Thus, for example, profiler 310 may monitor: exchanges 407A and 407B between code module A 405 and code module B 410; exchanges 412A and 412B between code module A 405 and code module C 415; and exchanges 417A and 417B between code module C 415 and code module D 420. Even further, block 510 may refer to profiler 310 monitoring any data or state exchange between any of modules 405, 410, 415, and 420 and runtime execution environment 200 or an OS in an unmanaged execution environment.

Block 515 may refer to profiler 310 collecting at least portions of the data monitored at block 510. Further, block 515 may refer to profiler 310 storing the monitored data locally on code isolating tool 300, on a component corresponding to runtime execution environment 200, or on a component corresponding to an OS in an unmanaged execution environment. Further still, profiler 310 may alternatively store the monitored data externally to a storage medium corresponding to one of processing devices 105, 110, or 115 (see FIG. 1) or to a network based storage system.

As set forth above, for each of monitored modules 405, 410, 415, and 420, profiler 310 may store input data and/or state with output data in a paired manner. That is, profiler 310 is to provide a direct linkage or pairing from input data and/or state to output data for each monitored module.

Further still, profiler 310 may filter out at least portions of an interaction between monitored modules 405, 410, 415, and 420, and a corresponding execution environment, such as runtime execution environment 200 or an OS in an unmanaged execution environment. As a result, one or more contentions that may arise from such interaction may be avoided, thus enabling a testing implementation that resembles a third-party customer processing scenario.

Block 520 may refer to builder 315, either individually or in combination with one or more components of runtime execution environment 200 or an OS in an unmanaged execution environment, isolating or otherwise extracting one or more of modules 405, 410, 415, and 420 to create a valid functional test for the one or more modules that are extracted. That is, builder 315 may isolate modules 405, 410, 415, and 420, either singularly or in various combinations thereof, using technologies for identifying and extracting methods, classes, DLLs (dynamic link libraries), frameworks, or other depictions of modules from an application, program, function, or other assemblage of code. Implementations of code module isolation 120 are not limited to the isolated modules 405, 410, 415, and 420 being methods, classes, DLLs (dynamic link libraries), frameworks. Any module of code capable of being identified and extracted may be subjected to such extraction.

Further, for the one or more isolated modules of code, builder 315 may further retrieve the stored input data and/or state and output data from, e.g., a local storage component corresponding to code isolating tool 300, runtime execution environment 200, or an OS in an unmanaged execution environment. As set forth above, since profiler 310 may store such data and/or state in a physical medium, the retrieval of such data may be implemented in an off-line manner; conversely, since profiler 310 may store such data and/or state in a network-based storage system, the retrieval of such data may be implemented using a network-based retrieval technique.

Consequently, by isolating one or more of modules 405, 410, 415, and 420, either singularly or in combination, builder 315 may effective copy one or more methods, classes, DLLs (dynamic link libraries), frameworks, etc. to functionally test the one or more extracted modules using real world input. Further, such testing may be validated against known output data expectations. That is, the one or more extracted modules may be re-executed with real-world input in a testing environment, and such testing may be validated because the expected output resulting from the real-world input is known.

By the description above, pertaining to FIGS. 1-5, one or more modules of code may be isolated to reproduce a functional test and implement a performance test in either a managed execution environment or an unmanaged execution environment. However, the example implementations described herein are not limited to just the environment of FIG. 1, the components of FIGS. 2 and 3, an execution path as in FIG. 4, or the process of FIG. 5. Technologies (e.g., tools, methodologies, and systems) associated with code module isolation 120 (see FIG. 1) may be implemented by various combinations of the components described with reference to FIGS. 2-4, as well as in various orders of the blocks described with reference to FIG. 5.

Further, the computer environment for any of the examples and implementations described above may include a computing device having, for example, one or more processors or processing units, a system memory, and a system bus to couple various system components.

The computing device may include a variety of computer readable media, including both volatile and non-volatile media, removable and non-removable media. The system memory may include computer readable media in the form of volatile memory, such as random access memory (RAM); and/or non-volatile memory, such as read only memory (ROM) or flash RAM. It is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electric erasable programmable read-only memory (EEPROM), and the like, can also be utilized to implement the example computing system and environment.

Reference has been made throughout this specification to “an example,” “alternative examples,” “at least one example,” “an implementation,” or “an example implementation” meaning that a particular described feature, structure, or characteristic is included in at least one implementation of the present invention. Thus, usage of such phrases may refer to more than just one implementation. Furthermore, the described features, structures, or characteristics may be combined in any suitable manner in one or more implementations.

One skilled in the relevant art may recognize, however, that code module initialization may be implemented without one or more of the specific details, or with other methods, resources, materials, etc. In other instances, well known structures, resources, or operations have not been shown or described in detail merely to avoid obscuring aspects of the invention.

While example implementations and applications of the code module initialization have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the invention, as both described above and claimed below.

We claim:

1. A technique, comprising:
executing a module of code associated with at least one application;
collecting at least data input to the module of code during the executing;
storing the collected data; and
isolating the module of code and the collected data.

2. A technique according to claim 1, wherein the module of code includes at least one method.

3. A technique according to claim 1, wherein the module of code includes at least one class.

4. A technique according to claim 1, wherein:
the collecting further includes collecting data output from the module of code as part of the executing; and
the storing further includes storing the collected data input to the module of code and the collected data output from the module of code in correspondence to each other.

5. A technique according to claim 1, wherein the collecting includes excluding a data exchange between the module of code and a corresponding execution environment.

6. A technique according to claim 1, wherein the storing is implemented by a profiler.

7. A technique according to claim 1, wherein the storing is implemented by way of instrumentation.

8. A technique according to claim 1, wherein the isolating includes re-executing the module of code by inputting the collected data.

9. A technique according to claim 1, wherein:
the collecting further includes collecting data output from the module of code as part of the executing; and
the isolating includes:
re-executing the module of code using the collected data input to the module of code, and
testing for an output to match the stored data output from the module of code as a result of the executing.

10. A system, comprising:
an executor to execute a module of code;
a profiler to store a data file related to execution of the module of code; and
a builder to:
extract the module of code from an application,
retrieve at least a portion of the data file from the profiler, and
re-execute the module of code using data from the data file.

11. A system according to claim 10, wherein the module of code includes a method class.

12. A system according to claim 10, wherein the data file includes state input to the module of code.

13. A system according to claim 10, wherein the data file includes data input to the module of code and data output from the module of code resulting from execution of the module of code.

14. A system according to claim 10, wherein, to store the data file, the profiler is to:
monitor the executor and interrupt execution of the module of code, and
inspect and store state input to the module of code.

15. A system according to claim 10, wherein the builder is to reproduce a functional behavior of the application from which the module of code is extracted.

16. A system according to claim 10, wherein, to extract the module of code, the builder is to isolate the module of code from at least one other module of code corresponding to the application.

17. A system according to claim 10, wherein the builder is to:
further extract another module of code from the application, the module of code and the another module of code being communicative during execution of the application, and
re-execute the module of code and the another module of code using data from the data file.

18. At least one computer-readable medium having executable instructions that, when read, cause one or more processors to:
monitor execution of a real-world process that includes at least two methods;
reproduce a functional behavior of a selected one of the methods;
test the selected method against valid data.

19. At least one computer-readable medium according to claim 18, wherein the one or more instructions to monitor execution of the real-world process cause the one or more processors to store input data that is input to the selected method, and wherein further the valid data includes data output by the selected method after the input data is input to the selected method during execution of the real-world process.

20. At least one computer-readable medium according to claim 19, wherein the one or more instructions to reproduce functional behavior of the selected method excludes interaction between the selected method and an execution environment.
